(19) United States
(12) Patent Application Publication
(10) Pub. No.: US 2024/0131911 A1
(43) Pub. Date: Apr. 25, 2024

(54) VEHICLE SEALING MATERIAL

(71) Applicant: KASEI KOGYO CO., LTD., Aichi (JP)

(72) Inventor: Yoshiharu OSAWA, Aichi (JP)

(73) Assignee: KASEI KOGYO CO., LTD., Aichi (JP)

(21) Appl. No.: 18/490,751

(22) Filed: Oct. 19, 2023

(30) Foreign Application Priority Data
Oct. 21, 2022 (JP) 2022-168013

(51) Int. Cl. B60J 10/16; B60J 10/70

(52) U.S. Cl. CPC B60J 10/16; B60J 10/70

(57) ABSTRACT

A vehicle sealing material to be mounted between a front windshield and a headlamp includes: a seal base section installed along the periphery of the front windshield; and a seal lip section extending from one end of the seal base section, contacting a part of the headlamp, and having a hollow cross-sectional shape that is elastically deformable. The seal lip section is the same elastic deformation shape during installing the front windshield to the vehicle body along the front windshield installing direction, and during replacing the headlamp along the headlamp replacing direction, being different from the front windshield installing direction.

### RELATED APPLICATIONS

The present application is an application based on JP-2022-168013 filed on Oct. 20, 2022 with Japan Patent Office, the entire contents of which are incorporated herein by reference.

### BACKGROUND OF THE INVENTION

### Field of the Invention

The present invention relates to a vehicle sealing material. More particularly, the present invention relates to the sealing material for vehicles mounted between a front windshield and a headlamp.

In recent years, in addition to gasoline-powered vehicles and diesel-powered vehicles that use fossil fuels such as gasoline and diesel oil as their energy sources, Various “next-generation vehicles” have been developed and commercialized, such as hybrid vehicles (HV) using gasoline engines and electric motors in combination, electric vehicles (EV) that drive electric motors using electricity filled in batteries, fuel cell vehicles (FCV) that supply hydrogen to fuel cells and drive electric motors using electricity obtained through chemical reactions, and natural gas vehicles (CNG) that use natural gas as an energy source.

Since the vehicle structure of the next-generation vehicles differs from that of conventional gasoline-powered vehicles etc., The design and vehicle structure can incorporate new design concepts. In the case of conventional gasoline-powered vehicles, the drive system is generally FF (front engine front drive), FR (front engine rear drive), which requires an engine compartment in the front of the vehicle body for mounting an engine. On the other hand, in the case of electric vehicles and the like, since a space for mounting a battery is provided in the lower part of the vehicle and the electric motor is mounted in a distributed manner at a position close to each tire, there is no need to provide a space for the engine room as described above in the front part of the vehicle.

Therefore, in the case of next-generation vehicles such as electric vehicles, it is possible to design a new vehicle structure without being limited to the design constraints imposed on conventional gasoline-powered vehicles, and it is possible to design various types of next-generation vehicles. For example, it is possible to adopt a vehicle structure in which a front windshield and a headlamp are laid out to be close to a front part of a vehicle body, which is difficult for a conventional small-sized vehicle, medium-sized gasoline-powered vehicle, and the like due to a problem of space in an engine room.

On the other hand, in a conventional gasoline-powered vehicle and the like, a vehicle sealing material (vehicle door sealing material) capable of exhibiting a high sealing property such as water cut-off property even when a door opening operation or a closing operation is performed on a door panel, a vehicle opening section, or the like is used (for example, See, Patent Document 1).

Further, it is known in the art that when a gap is formed between the front windshield and a vehicle body surrounding the front windshield, wind noise caused by the gap is generated during driving. The generation of wind noise may cause noise, which may impair the comfort of driving. Therefore, in order to solve such a problem, a vehicle sealing material formed of an elastically deformable rubber material along the periphery of the front windshield is mounted to prevent a gap between the front windshield and the vehicle body and to suppress the occurrence of the wind noise.

Therefore, even in the next-generation vehicles having a vehicle structure in which the above-described front windshield and the headlamp are laid out to be close to each other, a countermeasure for preventing the generation of wind noise using a vehicle sealing material is required between a front windshield and a headlamp.
[Patent Document 1] JP-A-2015-055345

However, when a new vehicle structure in which the front windshield and the headlamp are close to each other is adopted as described above, there is a possibility that the following problems may occur. That is, there is a possibility that a failure such as a lamp breakage may occur due to an impact such as an aging use or an accident, and a headlamp to be replaced (hereinafter, referred to as “old headlamp”) installed to a vehicle body needs to be removed, and a headlamp to be replaced with a new headlamp (hereinafter, referred to as “new headlamp”) installed to the vehicle body needs to be replaced.

Here, in order to manufacture general vehicles or the like (including a next-generation automobile such as an electric vehicle), it is necessary to perform vehicle assembly work to assemble various components. In the case of a vehicle in which a front windshield and a headlamp are laid out to be close to each other, generally, a front windshield in which a vehicle sealing material is mounted is brought close to a headlamp that has already been installed to the vehicle body (chassis), and an operation of assembling the front windshield to the vehicle body is performed while elastically deforming a seal lip section (described in detail later) of the vehicle sealing material.

By the vehicle assembly work, the seal lip section of the vehicle sealing material comes into contact with a part of the headlamp in an elastically deformed state, and the gap formed between the front windshield and the headlamp can be filled while keeping the state of the elastic deformation. As a result, it is possible to suppress problems such as the generation of wind noise during driving. That is, in the case of the vehicle assembly, an operation of bringing the front windshield (and the vehicle sealing material) close to the headlamp that has already been fixed is performed.

On the other hand, in the case of the headlamp replacement work for replacing the headlamp that has been broken due to aging or the like, it is necessary to remove the old headlamp to be replaced from the vehicle body, and then perform the work of installing the new headlamp to the vehicle body to be close to the front windshield. That is, when the headlamp is replaced, an operation of bringing the headlamp close to the front windshield (and the vehicle sealing material) fixed to the vehicle body is performed.

Here, when the old headlamp is removed from the vehicle body, the vehicle sealing material mounted in an elastically deformed state between the front windshield and the old headlamp is released from the elastically deformed state of the seal lip section that has been elastically deformed.

In other words, when the headlamp is replaced so that the new headlamp is brought close to the front windshield, it is necessary to operate by contacting the seal lip section (vehicle sealing material) in a state of being restored from the elastic deformation to the vehicle body while elastically deforming the seal lip section with a part of the new headlamp. As a result, the direction of the force applied to elastically deform the vehicle sealing material during vehicle assembly is different from the direction of the force applied to elastically deform the vehicle sealing material during headlamp replacement.

As described above, since the direction of the force applied to the vehicle sealing material is different between the vehicle assembly time and the headlamp replacement time, there is a possibility that the shape (state) of the elastic deformation of the vehicle sealing material mounted between the front windshield and the headlamp after each operation is different. As a result, it is not possible to sufficiently close the gap between the front windshield and the headlamp, and it is sometimes difficult to ensure sufficient seal stability, such as not being able to suppress the generation of wind noise. Therefore, it is necessary to make the shape of the elastic deformation of the vehicle sealing material substantially coincide with each other both at the time of assembling the vehicle and at the time of changing the headlamp.

In addition, in the vehicle sealing material mounted between the front windshield and the headlamp, a part of the seal lip section after the elastic deformation may protrude from between the front windshield and the headlamp, and for pedestrian protection when the vehicle and the pedestrian come into contact with each other, it is necessary to limit the protruding amount of the part of the seal lip section (the seal protruding section, which will be described in detail later) after the elastic deformation within a predetermined range under a predetermined pedestrian protection safety standard.

In view of the above circumstances, it is an object of the present invention to provide a vehicle sealing material that is arranged in a vehicle such as an electric vehicle in which a front windshield and a headlamp are laid out to be close to each other, and which enables stable elastic deformation of a seal lip section at the time of any operation at the time of assembling the vehicle and at the time of replacing the headlamp, and which satisfies the requirements of pedestrian safety standards.

### SUMMARY OF THE INVENTION

As a result of intensive research to solve the above problems, the present inventors have found that the above problems can be solved by improving the shape of the seal lip section, the material to be used, and the like, and have completed the present invention described below.

[1] A vehicle sealing material to be mounted between a front windshield and a headlamp, including: a seal base section installed along the periphery of the front windshield; and a seal lip section extending from one end of the seal base section, contacting a part of the headlamp, and having a hollow cross-sectional shape that is elastically deformable, wherein the seal lip section is same elastic deformation shape during installing the front windshield to a vehicle body by bringing the front windshield with the vehicle sealing material close to the headlamp pre-installed on the vehicle body along the front windshield installing direction, and during replacing the headlamp by bringing the headlamp close to the front windshield with the vehicle sealing material along the headlamp replacing direction, being different from the front windshield installing direction.

[2] The vehicle sealing material according to the above [1], wherein the seal lip section further including: a lip base section extending from the seal base section; a pair of oblique lip sections extending along an oblique direction from a lip tip end section and lip base end section of the lip base section, respectively; and a connecting lip section connecting between the pair of oblique lip sections, wherein the hollow cross-sectional shape of the seal lip section is formed by the lip base section, the pair of oblique lip sections, and the connecting lip section to form a cross-sectional quadrilateral shape, wherein the cross-sectional quadrilateral shape is changed by elastic deformation of the seal lip section.

[3] The vehicle sealing material according to the above [2], in the seal lip section mounted between the front windshield and the headlamp and is in a state of elastic deformation, a protruding position of a seal protruding end section to which one the oblique lip section and the connecting lip section are connected is located within a predetermined range with reference to the virtual contact circle contacting the front windshield and the headlamp, respectively.

[4] The vehicle sealing material according to the above [2] or [3], wherein the lip base section including the seal base section and a part of seal lip section, are formed of same material, wherein the pair of oblique lip sections and the connecting lip section are formed of same material and are formed of different material from the seal base section and the lip base section.

[5] The vehicle sealing material according to the above [4], wherein the seal base section and the lip base section are formed of hard rubber material, wherein the pair of oblique lip sections and the connecting lip section are formed of soft foam sponge material having different specific gravity and hardness from the hard rubber material.

[6] The vehicle sealing material according to the above [5], wherein the hard rubber material is hard rubber made from ethylene-propylene-diene rubber, wherein the soft foam sponge material is a spongy ethylene-propylene-diene rubber made from ethylene-propylene-diene rubber.

The vehicle sealing material of the present invention can substantially match the shape of the elastic deformation of the seal lip section both at the time of vehicle assembly and at the time of headlamp replacement and can ensure sufficient seal stability. Furthermore, the seal protruding end section of the seal lip section after the elastic deformation can be located within a predetermined range to meet the requirements of predetermined pedestrian protection safety standards.

### BRIEF DESCRIPTION OF THE DRAWINGS

FIG. 1 is an explanatory view showing the schematic configuration of vehicle sealing material according to the present embodiment.

FIG. 2 is an enlarged cross-sectional view of B-B′ line of FIG. 1, showing the schematic configuration of vehicle sealing material.

FIG. 3 is an enlarged cross-sectional view of A-A′ line of FIG. 1, showing the schematic configuration of vehicle sealing material.

FIG. 4 is an enlarged cross-sectional view of C-C′ line of FIG. 1, showing the schematic configuration of vehicle sealing material.

FIG. 5A is an explanatory view showing an embodiment of the elastic deformation of the vehicle sealing material in the vicinity of B-B′ of FIG. 1 at the time of vehicle assembly before installing the front windshield and FIG. 5B is an explanatory view showing an embodiment of the elastic deformation of the vehicle sealing material in the vicinity of B-B′ of FIG. 1 at the time of vehicle assembly after installing the front windshield.

FIG. 6A is an explanatory view showing an example of the elastic deformation of the vehicle sealing material in the vicinity of B-B′ line of FIG. 1 at the time of headlamp replacement before replacing headlamp, FIG. 6B is an explanatory view showing an example of the elastic deformation of the vehicle sealing material in the vicinity of B-B′ line of FIG. 1 at the time of headlamp replacement during replacing headlamp, and FIG. 6C is an explanatory view showing an example of the elastic deformation of the vehicle sealing material in the vicinity of B-B′ line of FIG. 1 at the time of headlamp replacement after replacing headlamp.

FIG. 7A is an explanatory view showing an example of the elastic deformation of the vehicle sealing material in the vicinity of A-A′ line of FIG. 1 at the time of vehicle assembly before installing the front windshield and FIG. 7B is an explanatory view showing an example of the elastic deformation of the vehicle sealing material in the vicinity of A-A′ line of FIG. 1 at the time of vehicle assembly after installing the front windshield.

FIG. 8A is an explanatory view showing an example of the elastic deformation of the vehicle sealing material in the vicinity of A-A′ line of FIG. 1 at the time of headlamp replacement before replacing headlamp, FIG. 8B is an explanatory view showing an example of the elastic deformation of the vehicle sealing material in the vicinity of A-A′ line of FIG. 1 at the time of headlamp replacement during replacing headlamp, and FIG. 8C is an explanatory view showing an example of the elastic deformation of the vehicle sealing material in the vicinity of A-A′ line of FIG. 1 at the time of headlamp replacement after replacing headlamp.

### DESCRIPTION OF THE PREFERRED EMBODIMENTS

The following describes embodiments of a vehicle sealing material of the present invention. The present invention is not limited to the following embodiments, to which changes, modifications, and improvements may be added without deviating from the scope of the invention.

1. Vehicle Sealing Material

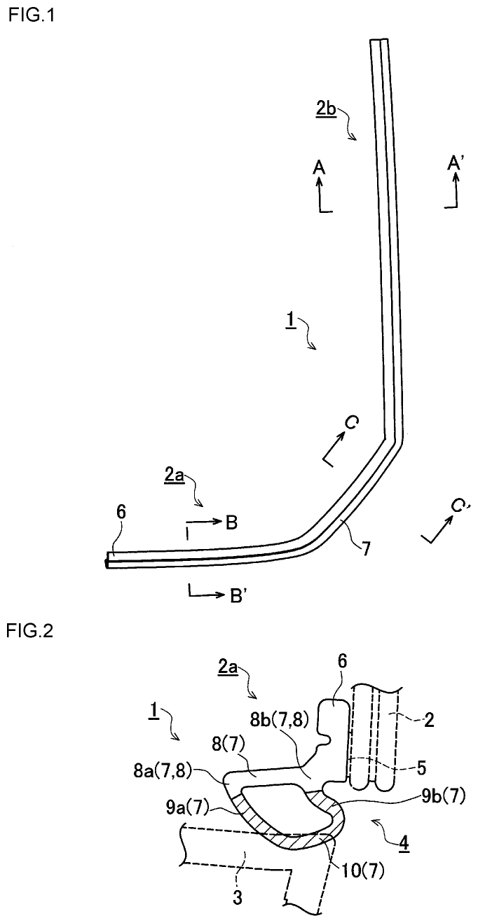

The vehicle sealing material 1 (hereinafter, simply referred to as “sealing material 1”) of one embodiment of the present invention is used in an electric vehicle (not shown) in which the front windshield 2 and the headlamp 3 are laid out to be close to each other as shown in FIGS. 1-8 and is mounted between the front windshield 2 and the headlamp 3 to close a gap 4 formed between the front windshield 2 and the headlamp 3 and to suppress the generation of wind noise and the like during driving.

The vehicle sealing material of the present invention is not limited to the above-described use in the electric vehicle, and can be used in current gasoline-powered vehicles, diesel-powered vehicles with the front windshield and the headlamp laid out in close proximity, as well as in various other next-generation vehicles.

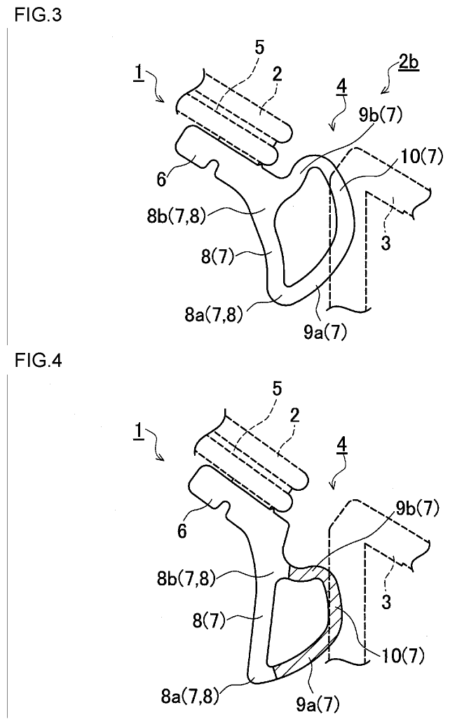

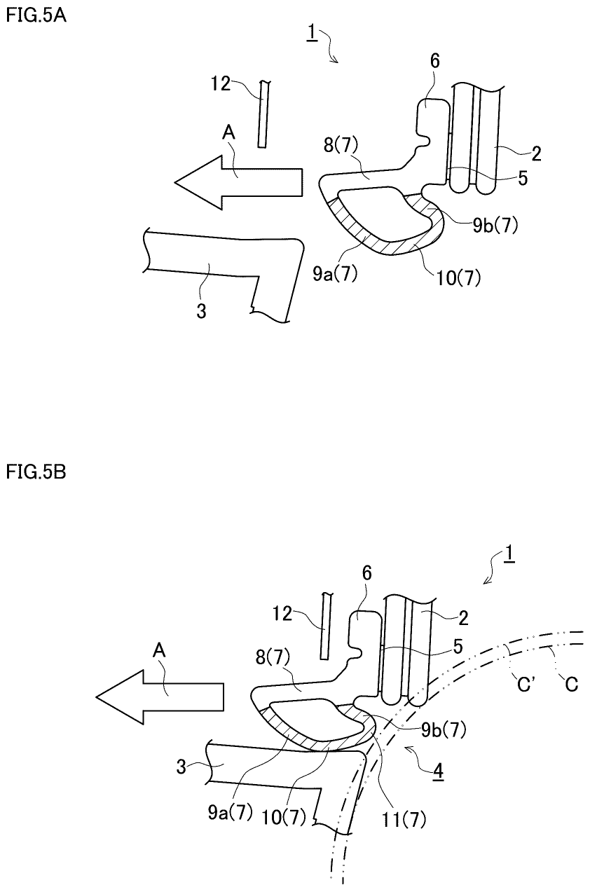

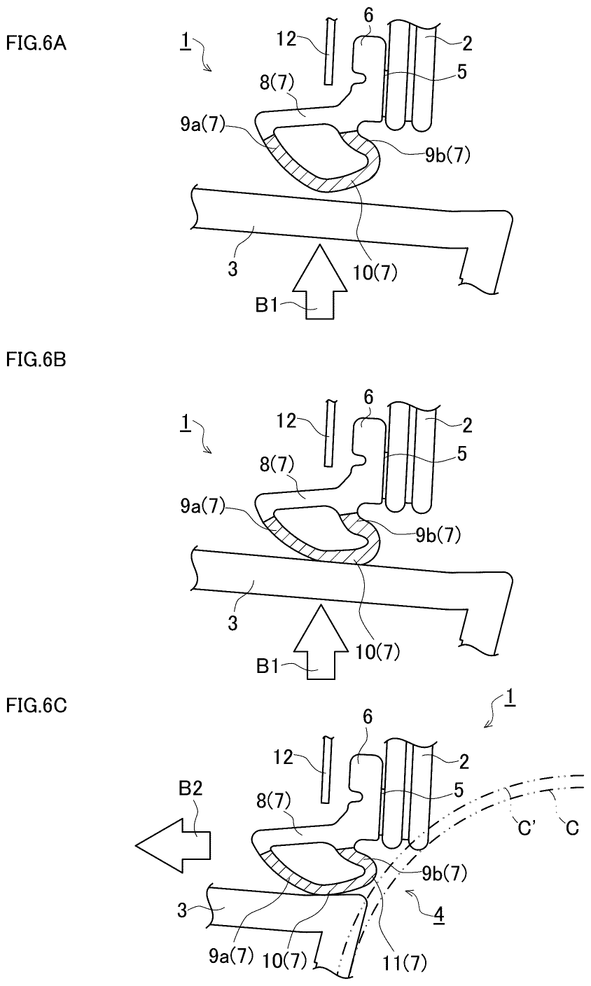

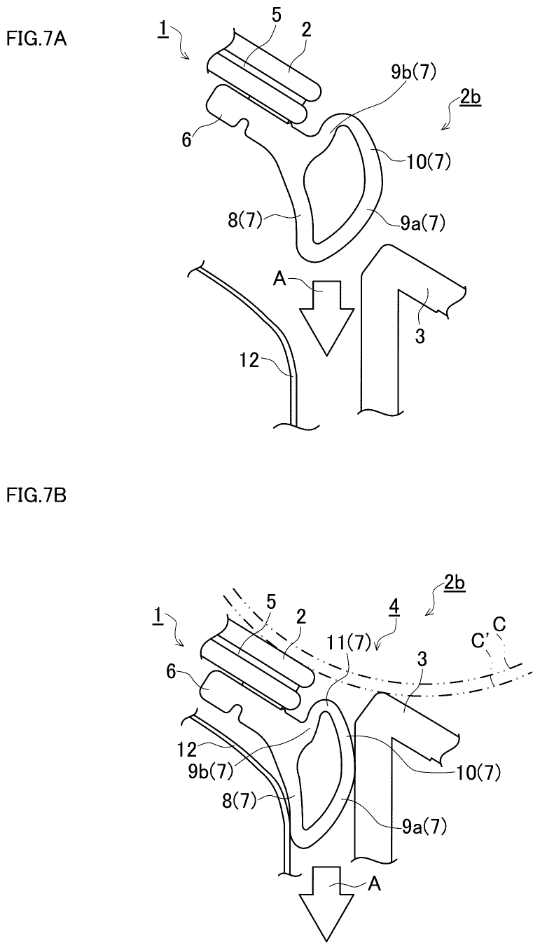

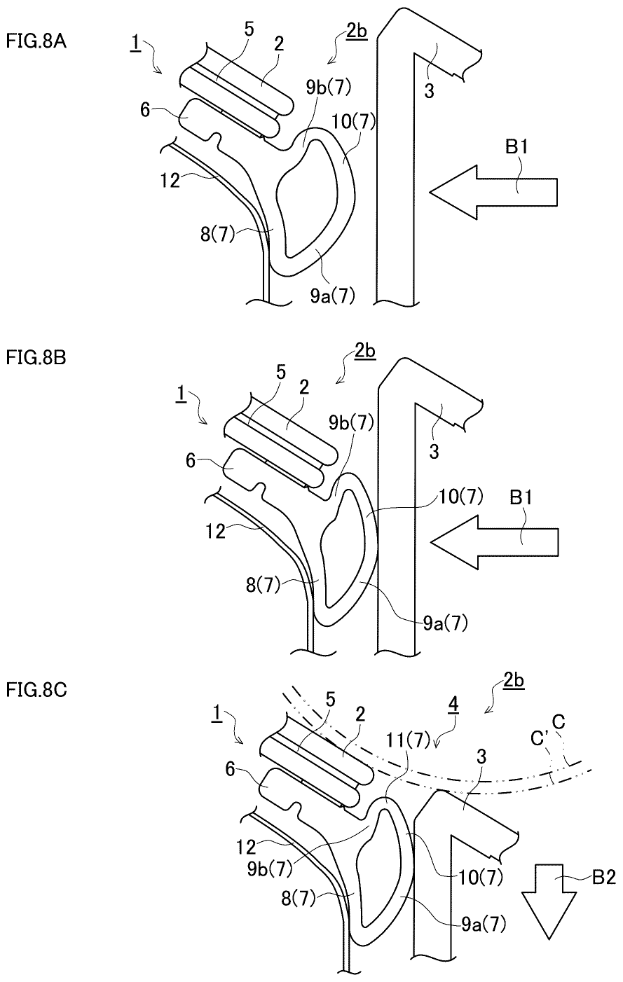

Here, FIG. 1 is an explanatory view showing the schematic configuration of vehicle sealing material according to the present embodiment, FIG. 2 is an enlarged cross-sectional view of B-B′ line of FIG. 1, showing the schematic configuration of vehicle sealing material, FIG. 3 is an enlarged cross-sectional view of A-A′ line of FIG. 1, showing the schematic configuration of vehicle sealing material, FIG. 4 is an enlarged cross-sectional view of C-C′ line of FIG. 1, showing the schematic configuration of vehicle sealing material, FIG. 5A is an explanatory view showing an embodiment of the elastic deformation of the vehicle sealing material in the vicinity of B-B′ of FIG. 1 at the time of vehicle assembly before installing the front windshield and FIG. 5B is an explanatory view showing an embodiment of the elastic deformation of the vehicle sealing material in the vicinity of B-B′ of FIG. 1 at the time of vehicle assembly after installing the front windshield, FIG. 6A is an explanatory view showing an example of the elastic deformation of the vehicle sealing material in the vicinity of B-B′ line of FIG. 1 at the time of headlamp replacement before replacing headlamp, FIG. 6B is an explanatory view showing an example of the elastic deformation of the vehicle sealing material in the vicinity of B-B′ line of FIG. 1 at the time of headlamp replacement during replacing headlamp, and FIG. 6C is an explanatory view showing an example of the elastic deformation of the vehicle sealing material in the vicinity of B-B′ line of FIG. 1 at the time of headlamp replacement after replacing headlamp, FIG. 7A is an explanatory view showing an example of the elastic deformation of the vehicle sealing material in the vicinity of A-A′ line of FIG. 1 at the time of vehicle assembly before installing the front windshield and FIG. 7B is an explanatory view showing an example of the elastic deformation of the vehicle sealing material in the vicinity of A-A′ line of FIG. 1 at the time of vehicle assembly after installing the front windshield, FIG. 8A is an explanatory view showing an example of the elastic deformation of the vehicle sealing material in the vicinity of A-A′ line of FIG. 1 at the time of headlamp replacement before replacing headlamp, FIG. 8B is an explanatory view showing an example of the elastic deformation of the vehicle sealing material in the vicinity of A-A′ line of FIG. 1 at the time of headlamp replacement during replacing headlamp, and FIG. 8C is an explanatory view showing an example of the elastic deformation of the vehicle sealing material in the vicinity of A-A′ line of FIG. 1 at the time of headlamp replacement after replacing headlamp.

As shown in FIGS. 1 and 2 and the like, the sealing material 1 of the present embodiment is configured to exhibit an elongated body that can be installed along the periphery of the front windshield 2, and is installed to the front windshield 2 using a well-known fixing means such as a double-sided tape 5. FIG. 1 illustrates a part of sealing material 1 installed along the periphery of the front windshield 2. Further, in FIGS. 2-4, the front windshield 2, and the headlamp 3 are shown using dashed lines.

The sealing material 1 of the present embodiment includes, as its basic configuration, a seal base section 6 installed to the front windshield 2, a seal lip section 7 extending from one end of the seal base section 6 and contacting a part of the headlamp 3 and having an elastically deformable hollow cross-sectional shape.

The sealing material 1 of this embodiment includes the above-described seal lip section 7 which can be stably filled while elastically deforming the gap between the front windshield 2 and the headlamp 3 during vehicle assembly to be assembled with the front windshield 2 to the vehicle body 12 (refer to FIG. 5A and the like) and during the headlamp replacement by maintenance or the like.

Here, as shown in FIG. 2, the configuration of the seal lip section 7 includes a lip base section 8 extending from one end of the seal base section 6 installed to the front windshield 2 along a predetermined direction (substantially perpendicular direction in FIG. 2), a pair of oblique lip sections 9a,9b extending in parallel from the lip tip end section 8a and the lip base end section 8b of the lip base section 8 along an oblique direction (obliquely downward direction in FIG. 2), and a connecting lip section 10 connecting the pair of oblique lip sections 9a,9b.

With the above configuration, the hollow cross-sectional shape of the seal lip section 7 is configured to have a cross-sectional quadrilateral shape in which the lip base section 8, the pair of oblique lip sections 9a,9b, and the connecting lip section 10 are each a side, and in particular, a substantial parallelogram cross-sectional shape in FIG. 2.

The cross-sectional shape of the seal lip section 7 of the sealing material 1 shown in FIG. 2 is a cross-sectional position of B-B′ line in FIG. 1, and is not limited to this, and differs in cross-sectional shape at each section of the sealing material 1 of the elongated member. For example, at A-A′ line cross-sectional position of FIG. 1 as shown in FIG. 3, a cross-sectional substantially rhombic shape is provided, while at C-C′ line cross-sectional position of FIG. 1, as shown in FIG. 4, a cross-sectional substantially trapezoidal shape is provided.

That is, the seal lip section 7 of the sealing material 1 of the present embodiment is configured to have various cross-sectional quadrangular shapes with the lip base section 8, the pair of oblique lip sections 9a,9b, and the connecting lip section 10 as respective sides. In this way, even when a force is applied to the seal lip section 7 from a different direction since the seal lip section 7 has a cross-sectional square shape, stable sealing properties can be secured by deforming the square shape.

Furthermore, as shown in FIGS. 2 and 4, the sealing material 1 of the present embodiment can be made of two different types of materials. Specifically, as shown in FIG. 2, the seal base section 6 constituting the sealing material 1, and the lip base section 8 which is a part of the seal lip section 7 are formed of a hard rubber (hereinafter referred to as a “hard rubber EPDM”) made of ethylene-propylene-diene rubber as a raw material having the properties of rubber elastically deformable by strong stress. That is, it is elastically deformable to a strong stress, in the case of a relatively weak stress, exhibits a property that does not elastically deform against the stress, and has a constant strength and hardness.

On the other hand, the oblique lip section 9a,9b and the connecting lip section 10 of the seal lip section 7 are made of a spongy ethylene-propylene-diene rubber (hereinafter referred to as “sponge EPDM”) having a plurality of voids therein and having sponge properties that are relatively easily elastically deformable against stresses. That is, the hard rubber EPDM described above is not elastically deformable, exhibits elastically deformable properties even at relatively weak stresses, and has lower strength and hardness than the hard rubber EPDM. Here, the hard rubber EPDM corresponds to the hard rubber material of the present invention, and the sponge EPDM corresponds to the soft foam sponge material of the present invention.

That is, in the sealing material 1, the seal base section 6 and the lip base section 8 are formed of a hard rubber EPDM which is hard rubber material of same material, while the oblique lip sections 9a,9b and the connecting lip section 10 are formed of a sponge EPDM of same material and are formed of a material other than the hard rubber EPDM of the seal base section 6 and the lip base section 8.

Therefore, the seal lip section 7 of the sealing material 1 of the present embodiment is formed of two kinds of materials in which the strength, hardness, and the like are different and the degree of elastic deformation to stress is different. As described above, the vehicle sealing material 1 of the present invention does not need to be formed of two types of materials, i.e., a hard rubber EPDM and a sponge EPDM, and may be formed of only one of them depending on a part. For example, as shown in FIG. 3, in the vicinity of A-A′ line of FIG. 1 of the sealing material 1, it is formed of only a hard rubber EPDM.

Here, in the vehicle sealing material of the present invention, the hard rubber is exemplified as the hard rubber material, but the present invention is not limited thereto, and examples thereof include an olefin-based thermoplastic elastomer, a styrene-based thermoplastic elastomer, other rubber material, and other elastic material having rubber-like elasticity. Similarly, as the soft foam sponge material, ethylene-propylene-diene rubber is exemplified, but the soft foam sponge material is not limited thereto, and examples of the soft foam sponge material include an olefin-based thermoplastic elastomer, a styrene-based thermoplastic elastomer, other rubber material, and other elastic material having rubber-like elasticity.

As described above, by using two types of materials having different properties such as strength, hardness, and specific gravity from each other, such as sponge EPDM and hard rubber EPDM for the seal lip section 7, the degree of elastic deformation when a force is applied to the sealing material 1 (particularly, the seal lip section 7) is different. Here, the sponge EPDM and the hard rubber EPDM are well-known materials used in manufacturing resin-molded parts for vehicles, and a detailed explanation thereof will be omitted here.

In particular, at the time of vehicle assembly and at the time of the headlamp replacement, there is a possibility that a force is applied directly to the sealing material 1, in other words, a section (the oblique lip section 9a,9b and the connecting lip section 10) which may come into contact with a part of the headlamp 3 is formed of sponge EPDM, and can be easily elastically deformed against stresses. On the other hand, by forming the lip base section 8 which does not directly contact the headlamp 3 with the hard rubber EPDM, a part of the seal lip section 7 is elastically deformed without elastically deforming the seal lip section 7. That is, the lip base section 8 of the seal lip section 7 is not substantially deformed, and the pair of oblique lip sections 9a,9b and the connecting lip section 10 are elastically deformed, so that the cross-sectional square shape of the seal lip section 7 is changed.

As described above, the sealing material 1 of the present embodiment is manufactured using two types of materials having properties differing from each other, such as a sponge EPDM and a hard rubber EPDM. At this time, in the production of the sealing material 1, it is possible to use a technique of “co-extrusion molding” in which two types of materials are simultaneously extruded from a molding die. Such co-extrusion molding (or two-color extrusion molding) is well known in resin processing, rubber processing, and the like, and can simultaneously extrude a hard material and a soft material, or simultaneously extrude a transparent material and a coloring material, and can change the properties of a specific section of a product.

More specifically, a molding die (not shown) corresponding to the cross-sectional shape of the sealing material 1 is first set in a co-extrudable extrusion apparatus. On the other hand, the two raw material feeds provided in the extruder are each heated and adjusted to an extrudable viscosity. A sponge EPDM and a hard rubber EPDM are prepared in a flowable condition. In such a condition, the sponge EPDM and the hard rubber EPDM are pressed from the two raw material feeds by a predetermined extrusion pressure, and the extrusion molding is simultaneously performed from the molding die. At this time, by adjusting the extrusion pressure of the sponge EPDM and the hard rubber EPDM, respectively, it is possible to extrude the sponge EPDM and the hard rubber EPDM at predetermined positions of the molding die. Accordingly, the arrangement and ratio of the sponge EPDM and the hard rubber EPDM in the cross-section of the sealing material 1 can be made uniform.

The sponge EPDM and the hard rubber EPDM extruded from the molding die are cooled by contact with the surrounding outside air and lose fluidity. Then, after being extruded to a predetermined length (for example, about 500 mm), it is cut. As a result, a longitudinal workpiece composed of two types of materials is formed. By performing Thomson punching on the longitudinal workpiece, it is possible to form the above-described fixing holes, notches, and the like. As a result, the manufacturing of the sealing material 1 of the present embodiment is completed. Incidentally, Thomson punching is a well-known processing method for punching by pressing a processing material using a Thomson mold in which a blade is embedded in a plywood to be a base, the detailed description will be omitted here. In the manufacturing method of the vehicle sealing material 1 of the present embodiment, the above-described co-extrusion molding is exemplified, but the present invention is not limited thereto, and the sealing material 1 may be manufactured by using other known resin material molding processing techniques.

Further, details of the elastic deformation of the sealing material 1 of the present embodiment at the time of vehicle assembly and at the time of headlamp replacement will be described with reference to FIGS. 5A to 8C. Here, FIGS. 5A, 5B and 6A, 6B, 6C show the elastic deformation of the sealing material 1 at the time of vehicle assembly (FIGS. 5A and 5B) and at the time of the headlamp replacement (FIGS. 6A, 6B and 6C) near the front windshield bottom section 2a (near B-B′ line cross-sectional position in FIG. 1), while FIGS. 7A, 7B and 8A, 8B, 8C show the sectional deformation of the sealing material 1 at the time of vehicle assembly (FIGS. 7A and 7B) and at the time of the headlamp replacement (FIGS. 8A, 8B and 8C) near the front windshield side section 2b (near A-A′ cross-sectional position in FIG. 1) stepwise.

As shown in FIG. 5A, at the time of vehicle assembly, the headlamp 3 was already installed on the vehicle body 12 (lower left side in FIG. 5A. The front windshield 2 in a state where the sealing material 1 of the present embodiment is already installed, is brought closer to the headlamp 3 along the horizontal direction (see the left arrow in FIG. 5A, the front windshield installing direction A).

As a consequence, a part of the headlamp 3 and a part of the seal lip section 7 of the sealing material 1, more specifically, the oblique lip section 9a located on the left side of the paper in FIG. 5A, come into contact. As described above, the oblique lip section 9a is formed of a sponge EPDM and is easily elastically deformed by contacting against the headlamp 3.

Here, since the operation of installing the front windshield 2 is continuously performed, the oblique lip section 9a is deformed to be close to the lip base section 8 with the lip tip end section 8a of the lip base section 8 as a base point. Further, the connecting lip section 10 connected to the oblique lip section 9a is similarly deformed, and the oblique lip section 9b (corresponding to one of the oblique lip sections in the present disclosure) located on the right side of the drawing of FIG. 5A connected to the connecting lip section 10 is also deformed along with the connecting lip section 10.

As a result, as shown in FIG. 5B, the gap 4 between the front windshield 2 and the headlamp 3 can be filled by the elastic deformation of the sealing material 1. At this time, the seal lip section 7 is deformed such that the cross-sectional quadrangular shape is slightly crushed as compared with FIG. 5A. As a result, it is possible to suppress the generation of wind noise during driving.

Further, as shown in FIG. 5B, when the mounting of the front windshield 2 to the vehicle body is completed, one of the oblique lip section 9b and the connecting lip section 10 of the seal lip section 7 is connected, the protruding position of the seal protruding section 11 protruded by elastic deformation (protruding to the right in FIG. 5B) is a virtual contact circle C contacting against each of the front windshield 2 and the headlamp 3 (see the two-dot chain line in FIG. 5B) It is designed to be positioned within a predetermined range as a reference. Here, in the sealing material 1 of the present embodiment, a pedestrian protection base circle C′ obtained by adding +1 mm to the radius of the virtual contact circle C is assumed, and the seal protruding section 11 is not in contact with the pedestrian protection base circle C′.

That is, when the seal protruding section 11 of the sealing material 1 exceeds the pedestrian protection base circle C′ set with reference to the virtual contact circle C of the front windshield 2 and the headlamp 3 due to the elastic deformation, and protrudes to the right in the drawing in FIG. 5B, and comes out from the outside of the vehicle, there is a risk of impairing the safety of the pedestrian when the front windshield 2 or the headlamp 3 contacts the pedestrian. Therefore, as described above, the sealing material 1 of the present embodiment is designed such that the seal protruding section 11 is positioned within a predetermined range in the gap 4 formed between the front windshield 2 and the headlamp 3.

On the other hand, as shown in FIG. 6A, when the headlamp is replaced, the front windshield 2 to which the sealing material 1 is already contacted is fixed to the vehicle body 12. Here, FIG. 6A illustrates a state in which a headlamp to be replaced (corresponding to the above-described old headlamp) is already removed due to a lamp breakage or the like.

In this condition, the headlamp 3 (corresponding to the above-described new headlamp) to be newly installed is brought close to the front windshield 2 and the sealing material 1 from the lower side to the upper side (see the upper arrow in FIG. 6A, the first headlamp installing direction B1). That is, the first headlamp installing direction B1 is a direction different from the front windshield installing direction A previously shown in FIG. 5A and the like. Here, the first headlamp installing direction B1 corresponds to the headlamp installing direction in the present invention.

As a result, a part of the headlamp 3 and a part of the seal lip section 7 of the sealing material 1, more specifically, the contact point and vicinity of the oblique lip section 9a and the connecting lip section 10, come into contact. As described above, the oblique lip section 9a and the connecting lip section 10 are formed of a sponge EPDM, and are easily elastically deformed when in contact with the headlamp 3 which is close to the upward direction.

Here, since the work for replacing the headlamp 3 is carried out continuously, the oblique lip section 9a and the connecting lip section 10 are deformed such that the cross-sectional quadrilateral shape of the seal lip section 7 is collapsed with the lip tip end section 8a of the lip base section 8 and the connecting point (the seal protruding section 11) of the connecting lip section 10 and one of the oblique lip sections 9b as a base point (see FIG. 6B).

Further, the headlamp 3 is moved in the horizontal direction (see the left arrow in FIG. 6C and the second headlamp installing direction B2) while the headlamp 3 is in the upward direction and the seal lip section 7 is elastically deformed. Here, the second headlamp installing direction B2 corresponds to the headlamp installing direction in the present invention as well as the first headlamp installing direction B1.

As a result, as shown in FIG. 6C, the gap 4 between the front windshield 2 and the headlamp 3 can be closed by the elastic deformation of the sealing material 1. At this time, the seal lip section 7 is deformed such that the cross-sectional quadrilateral shape is slightly collapsed. Therefore, it is possible to suppress the generation of wind noise during driving. Further, FIG. 6C shows that the shape of the elastic deformation of the sealing material 1 coincides with that of FIG. 5B showing the completion of the installation of the front windshield 2 at the time of vehicle assembly. In addition, similarly, the protruding end position of the seal protruding section 11 is set so as not to come into contact with the aforementioned pedestrian protection base circle C′.

As described above, in the sealing material 1 of the present embodiment, even when the direction of the force applied to the sealing material 1 (the seal lip section 7) (the front windshield installing direction A and the first headlamp installing direction B1) is different from each other, the shape of the elastic deformation of the seal lip section 7 can be eventually matched or substantially matched. As a result, the gap 4 between the front windshield 2 and the headlamp 3 can be closed by the sealing material 1 of the present embodiment, sufficient sealing stability can be secured, and the generation of wind noise and the like can be suppressed.

Further, a state of elastic deformation of the seal lip section 7 at another position of the sealing material 1, that is, in the vicinity of the front windshield side section 2b, is described with reference to FIGS. 7A, 7B, 7C and FIGS. 8A, 8B, 8C. Here, in the vicinity of the front windshield side section 2b, the positional relation between the front windshield 2 (and the sealing material 1) and the headlamp 3 is different from that in FIGS. 5A and the like and 6A and the like. Therefore, as shown in FIG. 7A, the front windshield 2 to which the sealing material 1 is installed, is brought close to the headlamp 3 along the lower side of the sheet (see the lower arrow in FIG. 7A, the front windshield installing direction A). As is apparent from FIG. 5A and FIG. 7A, the respective front windshield installing directions A are different from each other.

As a result, as shown in FIG. 7B, the front windshield 2 is installed to the vehicle body 12 in a state where the sealing material 1 is mounted between the front windshield 2 and the headlamp 3. On the other hand, when the headlamp is replaced, as shown in FIG. 8A, the headlamp 3 is brought close to the front windshield 2 and the sealing material 1 is installed to the vehicle body 12 along the left direction (see the left arrow in FIG. 8A, the first headlamp installing direction B1). As a result, the seal lip section 7 in contact with the headlamp 3 is elastically deformed, the cross-sectional quadrilateral shape is collapsed in the longitudinal direction (see FIG. 8B), and the headlamp 3 is further moved from this state along the downward direction (see the downward arrow in FIG. 8C, the second headlamp installing direction B2).

As a result, as in FIG. 7B, the sealing material 1 can be elastically deformed between the front windshield 2 and the headlamp 3. As described above, even in the vicinity of the front windshield side section 2b, the elastic deformation of the seal lip section 7 of the sealing material 1 can be matched or substantially matched at both the time of vehicle assembly and the time of headlamp replacement.

Accordingly, the sealing material 1 of the present embodiment can be eventually formed into the same elastic deformation even when the front windshield installing direction A and the first headlamp installing direction B1 are different from each other at the time of vehicle assembly and the time of headlamp replacement.

### INDUSTRIAL APPLICABILITY

The vehicle sealing material of the present invention has applicability in an industrial technical field related to the manufacture of a next-generation vehicle such as an electric vehicle using a sealing material or a variety of vehicles such as an existing gasoline-powered vehicle and diesel-powered vehicle.

### DESCRIPTION OF REFERENCE NUMERALS

1: Sealing material (vehicle sealing material), 2: front windshield, 2a: front windshield bottom section, 2b: front windshield side section, 3: headlamp, 4: gap, 5: double-sided tape, 6: seal base section, 7: seal lip section, 8: lip base section, 8a: lip tip end section, 8b: lip base end section, 9a,9b: oblique lip section, 10: connecting lip section, 11: seal protruding section, 12: vehicle body, A: front windshield installing direction, B1: first headlamp installing direction (headlamp installing direction), B2: second headlamp installing direction (headlamp installing direction), C: virtual contact circle, C′: pedestrian protection base circle.

What is claimed is:

1. A vehicle sealing material to be mounted between a front windshield and a headlamp, comprising:
a seal base section installed along the periphery of the front windshield; and
a seal lip section extending from one end of the seal base section, contacting a part of the headlamp, and having a hollow cross-sectional shape that is elastically deformable,
wherein the seal lip section is same elastic deformation shape during installing the front windshield to a vehicle body by bringing the front windshield with the vehicle sealing material close to the headlamp pre-installed on the vehicle body along the front windshield installing direction, and while replacing the headlamp by bringing the headlamp close to the front windshield with the vehicle sealing material along the headlamp replacing direction, being different from the front windshield installing direction.

2. The vehicle sealing material according to claim 1,
wherein the seal lip section further comprising:
a lip base section extending from the seal base section;
a pair of oblique lip sections extending along an oblique direction from a lip tip end section and lip base end section of the lip base section, respectively; and
a connecting lip section connecting between the pair of oblique lip sections,
wherein the hollow cross-sectional shape of the seal lip section is formed by the lip base section, the pair of oblique lip sections, and the connecting lip section to form a cross-sectional quadrilateral shape, and
wherein the cross-sectional quadrilateral shape is changed by elastic deformation of the seal lip section.

3. The vehicle sealing material according to claim 2, in the seal lip section mounted between the front windshield and the headlamp and is in a state of elastic deformation, a protruding position of a seal protruding end section to which one the oblique lip section and the connecting lip section are connected is located within a predetermined range with reference to the virtual contact circle contacting the front windshield and the headlamp, respectively.

4. The vehicle sealing material according to claim 2,
wherein the lip base section including the seal base section and a part of seal lip section, are formed of same material, and
wherein the pair of oblique lip sections and the connecting lip section are formed of same material and are formed of different material from the seal base section and the lip base section.

5. The vehicle sealing material according to claim 4,
wherein the seal base section and the lip base section are formed of hard rubber material, and
wherein the pair of oblique lip sections and the connecting lip section are formed of soft foam sponge material having different specific gravity and hardness from the hard rubber material.

6. The vehicle sealing material according to claim 5,
wherein the hard rubber material is hard rubber made from ethylene-propylene-diene rubber, and
wherein the soft foam sponge material is a spongy ethylene-propylene-diene rubber made from ethylene-propylene-diene rubber.
